(19) United States
(12) Patent Application Publication
(10) Pub. No.: US 2015/0056338 A1
(43) Pub. Date: Feb. 26, 2015

(54) SALT COMPOSITIONS AND METHODS OF MAKING AND USING

(71) Applicant: S&P Ingredient Development LLC, Minnetonka, MN (US)

(72) Inventors: Sambasiva Rao Chigurupati, Omaha, NE (US); Pratik Nandan Bhandari, Lincoln, NE (US); Dharma R. Kodali, Plymouth, MN (US)

(73) Assignee: S&P Ingredient Development LLC, Minnetonka, MN (US)

(21) Appl. No.: 13/971,602

(22) Filed: Aug. 20, 2013

(51) Int. Cl. A23L 1/237; A23L 1/00

(52) U.S. Cl. CPC A23L 1/237; A23L 1/0055
USPC 426/97; 426/302; 426/649; 426/589; 426/619; 426/580

(57) ABSTRACT

The present invention is directed to methods for preparing a potassium chloride composition useful for reducing sodium content and flavoring low solid food products, including mixing potassium chloride, a taste modifier, and a fat, at a temperature above the melting point of the fat, and cooling the mixture below the melting point of the fat to form the salt composition. Embodiments further include the addition of other chloride compositions, including sodium chloride, to potassium chloride, a taste modifier and a fat.

### FIELD OF THE INVENTION

The present invention relates to potassium chloride compositions useful in flavoring low solid food products and methods used to make them. More particularly, the invention relates to potassium chloride compositions that can substitute for NaCl, and that include potassium chloride, a taste modifier, and a hydrophobic coating.

### BACKGROUND OF THE INVENTION

Sodium chloride (NaCl) has been a well known food ingredient since antiquity. While NaCl imparts a desirable taste and flavor to food, too much use can result in long term adverse health risks. Because of the proliferation of NaCl in prepared foods and other products found in a grocery store, many people exceed the average recommended daily intake. Exceeding the recommended daily intake of sodium is a significant risk factor in developing high blood pressure and a cause or contributing factor in the rising incidence of heart disease. As such, medical professionals and governmental authorities recommend a reduction in per capita NaCl consumption of from about 4000 mg per day to a level of about 2300 mg or less per day.

Dietary Guidelines issued in the U.S. in 2005 suggest a proposed consumption limit of 2300 mg of sodium per day and the National Academy of Science (NAS) even suggests 1500-2300 mg of sodium per day. Health advocates at the American Heart Association and the Centers for Disease Control supported changing the sodium limit to 1500 mg in the 2010 Dietary Guidelines. In fact, the 2010 Dietary Guidelines recommend that sodium intake be limited to 1500 mg per day for anyone over the age of 51, all African Americans, and anyone who has high blood pressure, chronic kidney disease, or diabetes. More than half of the American population falls under these categories, including children. The NAS also recommends a potassium consumption of 4,700 mg per day. Typically potassium consumption is less than half of that level.

Because of these and other reasons, there are a variety of NaCl substitutes in the market. The classical approach to the production of NaCl substitutes involves combining sodium and potassium salts, or occasionally magnesium salts, in various ratios, and adding a wide variety of other modifiers (e.g., additives, taste modifiers, flavor enhancers and masking agents) to this mix. The other additives are generally added to mask or at least partially reduce the generally metallic/bitter taste of potassium that has generally been associated with NaCl substitutes containing potassium and even magnesium. The processing techniques used to make these products include, among others, simple blending, agglomeration, extrusion cooking, and the like.

U.S. Pat. Nos. 7,989,016; 8,197,878; and 8,329,236 disclose using a hydrophilic material such as starch or maltodextrin to bind together potassium chloride along with a flavor/taste modifier and a flavor/taste enhancer. The product provides good results for foods with low water content.

U.S. Pat. No. 6,090,419 discloses sodium chloride, as the only salt or optionally with minor amounts of added potassium chloride and/or a flavorant, distributed uniformly throughout a fused binding matrix material. The final composition may be prepared by grinding the cooled fracturable matrix mass. Thus, it is possible that there are exposed crystals of NaCl in a final ground product. The binding matrix may include dextrins, sugars, modified starches, pre-gelled starches, hydrocolloids, proteins, gums, methylcelluloses, ethylcelluloses, corn syrup solids, and high-melting point fats. Preferably the matrix is made up of bland tasting ingredients that solubilize/hydrate quickly in order to provide quick salt release.

Generally, the taste of salt substitute mixtures without sodium chloride is unsatisfactory, so that most mixtures contain at least a portion of sodium chloride. However, even mixtures containing a portion of sodium chloride produce either a distinct off flavor or an inadequate NaCl taste, especially when the amount is intended not to differ significantly from the comparable amount of sodium chloride. In addition, using NaCl substitute mixtures with low solid food products is problematic because the components of the NaCl substitute mixture tend to separate. For example, the binder dissolves, thereby unmasking the unsatisfactory taste of the potassium chloride and reducing benefits of the NaCl substitute. As a further example, the flavor enhancer and the potassium chloride separate, thereby unmasking the unsatisfactory taste of the potassium chloride and reducing benefits of the NaCl substitute.

Thus, taste, functionality and consumer acceptance, not to mention cost, are all challenges in developing low sodium NaCl substitute compositions and, thus far, no suitable NaCl replacement exists for all applications.

### SUMMARY OF THE INVENTION

Accordingly, the problem of the lack of suitable compositions that are combinable with low solid food products while maintaining a taste sufficiently close to the taste of NaCl with minimal or no off flavors, while at the same time permitting the sodium content to be reduced in an economically feasible manner, continues to exist.

There is thus a need for improved NaCl substitutes, and methods of making such compositions, that are combinable with low solid food products while maintaining various properties, including a reduced sodium content, having an appearance comparable to that of sodium chloride, being free-flowing particulates, tasting sufficiently like NaCl, not having an off flavor or having a reduced off flavor, and functioning like sodium chloride.

These and other needs are addressed by the various embodiments of the present invention. The following presents a simplified summary of the invention to provide an understanding of some aspects of the invention. This summary is not an extensive overview of the invention and its various embodiments. It is intended neither to identify key or critical elements of the invention nor to delineate the scope of the invention but to present selected concepts of the invention together with the more detailed description presented below.

The present embodiments are directed generally to salt compositions and methods used to make them. Some embodiments are directed to salt compositions that include potassium chloride, a taste modifier, and a hydrophobic material, such as a fat. Various embodiments are directed to methods for preparing salt compositions that include mixing potassium chloride and a taste modifier, and coating the mixture with a hydrophobic layer, e.g., a fat layer, to form the salt composition. Examples of techniques for coating the salt mixture with a hydrophobic layer to form the salt composition include using a processing aid, such as an alcohol, to coat the mixture with a hydrophobic layer. The fat can be added to the salt mixture at a temperature above the melting point of the fat, and, after coating can be optionally cooled to a temperature below the melting point of the fat. The resulting salt composition can be free-flowing particulates, as is common table salt.

The present embodiments are further directed generally to food products that include a low solid food material; and a salt composition comprising potassium chloride, a taste modifier, and a fat, and methods to make food products that include combining a low solid food material and a salt composition, where the salt composition comprises potassium chloride, a taste modifier, and a fat.

Further, the present embodiments are also directed generally to salt compositions for use in low solid food products and methods used to make them. Various salt compositions disclosed herein include the potassium chloride compositions. Some embodiments are directed to salt compositions that blend the potassium chloride compositions of the present invention with NaCl in a KCl:NaCl ratio of from about 10 weight %:90 weight % to about 90 weight %:10 weight %, or with NaCl in a KCl:NaCl ratio of from about 55 weight %:45 weight % to about 95 weight %:5 weight %, or with NaCl in a KCl:NaCl ratio of greater than 50 weight %:less than 50 weight %. As used herein, % refers to weight % unless otherwise stated, and weight % is also referred to as wt. %. In embodiments, little or no NaCl is added to the KCl formulations of the present invention, because the effectiveness of the KCl formulations decreases with the addition of NaCl. While minor amounts of NaCl, e.g., less, and preferably much less, than the amount of KCl, can be added to the KCl formulations, it is preferable to add any desired NaCl to a food material separately from the KCl composition of the present invention.

These embodiments can provide a number of benefits. For example, they can provide improved salt compositions, and methods of making such compositions, that have reduced sodium content while at the same time being combinable with low solid food products while maintaining desirable functional properties, such as having an appearance comparable to that of sodium chloride, tasting sufficiently similar to NaCl, not having an off flavor or having a reduced off flavor, and functioning like sodium chloride. The methods disclosed herein may provide improvement in sodium reduction using potassium chloride without a water soluble binding agent. These and other advantages will be apparent from the disclosure contained herein.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

As used herein, “agglomeration” or “mixture” refers to a combination or mixture of components such that the constituent components in the combination or mixture are indistinguishable from one another upon non-magnified visual inspection. As used herein, “combination” or “mixture” may be used interchangeably and may mean that specific steps of mixing have or have not occurred. For example, components may be combined in a variety of ways as disclosed herein, including being combined in devices that are not referred to as mixers or mixing devices.

As used herein, “amalgamation” refers to a combination or mixture of components such that the constituent components in the combination or mixture are indistinguishable from one another upon magnified visual inspection.

As used herein, “dietary supplement” refers to any product that contains a “dietary ingredient” intended to supplement the diet. The “dietary ingredients” in these products may include: vitamins, minerals, herbs or other botanicals, amino acids, and substances such as enzymes and metabolites. Dietary supplements can also be extracts or concentrates.

As used herein, “modifier(s)” refers to additives used to mask the off flavors in reduced sodium compositions including potassium chloride, including masking agents, and flavor enhancers to enhance the flavor of reduced sodium compositions. For instance, potassium chloride and magnesium chloride are known to impart bitter, metallic, or other off flavors when used to reduce the sodium content in NaCl replacement compositions. To mask these off flavors, additives are used. Thus, the term “modifier(s)” is used herein to include flavor enhancers, taste modifiers, including organic acids, masking agents and other terms used in the art to refer to additives used to alter the taste or flavor of a KCl composition.

As used herein, “salt” means potassium chloride (KCl). Salt used itself to modify another word (e.g., salt composition and the like), means potassium chloride (KCl) modifying the other word. For example, salt composition means potassium chloride composition or KCl composition, where the salt composition can include other components of the salt compositions as defined herein.

As used herein, “potassium chloride composition(s)” includes potassium chloride that has been processed in accordance with methods disclosed herein.

As used herein, “similar appearance” refers to various aspects of an appearance. For instance, a “similar appearance” to NaCl may mean having a similar color or transparency, or a similar particle size as NaCl. A “similar appearance” to NaCl may mean having a similar free-flowing capability, such that the composition in question can be poured and flows like NaCl crystals, and in particular, NaCl crystals having a comparable particle size. Compositions may have a similar appearance without having a similar shape or surface area.

The embodiments and configurations described herein are neither complete nor exhaustive. As will be appreciated, other embodiments of the invention are possible utilizing, alone or in combination, one or more of the features set forth above or below.

### BRIEF DESCRIPTION OF THE DRAWINGS

FIG. 1 shows uncoated pure KCl at 50× magnification without additives or processing for comparison;

FIG. 2A shows pure KCl at 1000× magnification after processing without additives;

FIG. 2B shows pure KCl at 500× magnification after processing without additives;

FIG. 2C shows pure KCl at 100× magnification after processing without additives;

FIG. 3 shows a 70× scanning electron microscope (SEM) image of an illustrative 50 wt. % KCl, 50 wt. % NaCl Table 2 composition fed through an extruder at 25 rpm (50% KCL25 RPM) in accordance with embodiments of the present disclosure;

FIG. 4 shows a 500×SEM image of an illustrative 50 wt. % KCl, 50 wt. % NaCl Table 2 composition fed through an extruder at 25 rpm (50% KCL25 RPM) in accordance with embodiments of the present disclosure;

FIG. 5 shows a 1000×SEM image of an illustrative 50 wt. % KCl, 50 wt. % NaCl Table 2 composition fed through an extruder at 25 rpm (50% KCL25 RPM) in accordance with embodiments of the present disclosure;

FIG. 6 shows a 70×SEM image of an illustrative 100 wt. % KCl Table 1 composition fed through an extruder at 25 rpm (100% KCL25 RPM) in accordance with embodiments of the present disclosure;

FIG. 7 shows a 100×SEM image of an illustrative 100 wt. % KCl Table 1 composition fed through an extruder at 25 rpm (100% KCL25 RPM) in accordance with embodiments of the present disclosure;

FIG. 8 shows a 500×SEM image of an illustrative 100 wt. % KCl Table 1 composition fed through an extruder at 25 rpm (100% KCL25 RPM) in accordance with embodiments of the present disclosure;

FIG. 9 shows a 1000×SEM image of an illustrative 100 wt. % KCl Table 1 composition fed through an extruder at 25 rpm (100% KCL25 RPM) in accordance with embodiments of the present disclosure;

FIG. 10 shows a 70×SEM image of an illustrative 100 wt. % KCl Table 1 composition fed through an extruder at 50 rpm (100% KCL50 RPM) in accordance with embodiments of the present disclosure;

FIG. 11 shows a 500×SEM image of an illustrative 100 wt. % KCl Table 1 composition fed through an extruder at 50 rpm (100% KCL50 RPM) in accordance with embodiments of the present disclosure.

### DETAILED DESCRIPTION OF THE INVENTION

Unless defined otherwise, all technical and scientific terms used herein have the same meaning as is commonly understood by one of ordinary skill in the art. All patents, applications, published applications and other publications are incorporated by reference in their entirety. In the event that there is a plurality of definitions for a term herein, those provided in the Summary prevail unless stated otherwise.

The present embodiments are directed generally to salt compositions and methods used to make them. Some embodiments are directed to salt compositions that include potassium chloride, a taste modifier, and a fat. Various embodiments are directed to methods for preparing salt compositions that include mixing potassium chloride, a taste modifier, and a fat, with the help of a processing aid to provide salt particles encapsulated in a hydrophobic layer to form the salt composition. The hydrophobic layer can cover most of the surface of most of the potassium chloride particles, for example, at least 50 surface area %, at least 60 surface area %, at least 70 surface area %, at least 80 surface area %, at least 90 surface area %, at least 95 surface area %, at least 99 surface area %, 100 surface area % of the surfaces of the potassium chloride particles (with taste modifier) are coated by the hydrophobic layer on at least 50 wt. %, at least 60 wt. %, at least 70 wt. %, at least 80 wt. %, at least 90 wt. %, at least 95 wt. %, at least 99 wt. %, 100 wt. % of the potassium chloride particles. In an embodiment, most of the potassium chloride particles together with the taste modifier are individually coated by the hydrophobic layer, with at least 50 wt. %, at least 60 wt. %, at least 70 wt. %, at least 80 wt. %, at least 90 wt. %, at least 95 wt. %, at least 99 wt. %, 100 wt. % of the potassium chloride particles being individually coated.

The present embodiments are further directed generally to food products that include a low solid food material; and a salt composition comprising potassium chloride, a taste modifier, and a fat, and methods to make food products that include combining a low solid food material and a salt composition, where the salt composition comprises potassium chloride, a taste modifier, and a fat.

These embodiments can provide a number of benefits. For example, they can provide improved KCl compositions, including salt compositions containing NaCl, and methods of making such compositions, that have reduced sodium content while at the same time being combinable with low solid food products while maintaining desirable properties, such as having an appearance comparable to that of sodium chloride, tasting sufficiently similar to NaCl, not having an off flavor or having a reduced off flavor, and functioning like sodium chloride. The methods disclosed herein can provide improvement in sodium reduction using potassium chloride without use of a water soluble sugars or starch based binding agents having glass transition.

In various embodiments, processes for making salt compositions having a similar appearance to NaCl and taste as NaCl, even when combined with low solid food products, and can substitute NaCl while having reduced sodium content, have been discovered.

Further embodiments include salt compositions having potassium chloride compositions of the present invention that provide improved taste, thereby allowing greater amounts of potassium chloride to be used, including when combined with low solid food products. Further, the salt compositions may not require one or more, and may exclude or be in the absence of, the usual modifiers and/or binders for masking the bitterness or off-taste of non-sodium chlorides, such as potassium chloride.

Related to the processes, resultant salt compositions that include potassium chloride compositions, which have reduced bitterness, even when combined with low solid food compositions, have been discovered. This is advantageous over prior art NaCl substitute compositions because prior art NaCl substitute compositions are primarily mixtures of NaCl with potassium chloride having a metallic taste, bitterness, or off flavor. Further, prior art NaCl substitute compositions would lose or reduce any advantageous taste properties when combined with low solid food products because, for example, the binder would dissolve and the potassium chloride would separate from any modifier(s). In particular, the use of potassium chloride in NaCl substitute compositions and food products is limited by its taste. More specifically, potassium chloride has a generally metallic/bitter taste, and the combination of bitter taste sensations in combination with the taste sensation of NaCl is perceived as off flavors. Thus, NaCl compositions containing potassium chloride and potassium chloride alone of the prior art often include modifiers to mask the perception of any metallic/bitter taste and off flavors. The NaCl compositions containing potassium chloride and potassium chloride alone of the prior art may also include binders to bind any modifiers to the potassium chloride to mask the perception of any metallic/bitter taste and off flavors.

Potassium chloride compositions disclosed herein may have a flavor that is less metallic and/or bitter as compared to prior art NaCl substitute compositions when included in low solid food products. This is advantageous over prior art NaCl substitute compositions, including NaCl substitute compositions containing potassium chloride, because prior art potassium chloride and NaCl substitute compositions have a generally metallic/bitter taste when included in low solid food products, thereby limiting the use of potassium chloride due to the undesirable taste. NaCl substitute compositions of the prior art include binders and/or modifiers to mask the perception of off flavors.

Potassium chloride compositions disclosed herein can be formed as free-flowing particulate materials. For example, after the compositions are coated with a hydrophobic layer such as a fat layer, and optionally cooled, the resulting compositions can have free-flowing capabilities similar to that of NaCl salt. No grinding of the composition is necessary. In this way, the compositions disclosed herein can be handled in a manner analogous to how NaCl is handled, including handling during packaging and use, when it can be advantageous to have a free-flowing material.

The surprising and unexpected nature of this discovery can be appreciated by reference to the literature, which abundantly reports the generally metallic and/or bitter taste of non-sodium chlorides (e.g., potassium chloride and magnesium chloride), and the multiplicity of additives, other than sodium chloride, which have been used to alter this unpleasant taste. The fact that salt compositions of the present invention, have reduced or eliminated the metallic taste, bitterness, and/or off flavors associated with potassium chloride of the prior art, even when combined with low solid food products, is completely unexpected and entirely unpredictable.

Compositions

In embodiments, the salt compositions of the present invention, that include potassium chloride, a taste modifier, and a fat, and optionally NaCl, can have less sodium, but still have the similar taste and a similar appearance to that of a composition that includes only NaCl. Additional compositions of the present disclosure include food products using the salt compositions disclosed herein; for example, a low solid food material and a salt composition including potassium chloride, a taste modifier, and a fat.

Low solid food products are food products that have some dissociation between the solid and liquids contained therein. They may be measured, for example, by water content, e.g., food products having an amount of water of at least about 70 wt. % in combination with 30 wt. % or less solids and/or other non-aqueous materials. Low solid food products may be food products having at least about 80 wt. % water and about 20 wt. % or less solids and/or other non-aqueous materials, or at least about 90 wt. % water and about 10 wt. % or less solids and/or other non-aqueous materials. Low solid food products can include soups, porridges, sauces, dairy products (including margarine), gravies, and salad dressings, among others.

In various embodiments, the salt composition is a composition including potassium chloride, a taste modifier and a fat, without additional components. In further embodiments, the salt composition is a composition of potassium chloride and a composition selected from sodium salts, potassium salts, magnesium salts, calcium salts, and combinations thereof. The sodium composition may be a chloride salt, and the salt composition may include sodium chloride. The salt composition may further include a non-sodium chloride salt, and the non-sodium chloride salt may be selected from potassium chloride, magnesium chloride, calcium chloride, and combinations thereof. In embodiments, organic components may be added before, during, and/or after the steps of the present disclosure.

Further, the salt compositions may be low sodium NaCl compositions by blending sodium chloride with a potassium chloride composition as disclosed herein. The salt compositions may include ratios of potassium chloride to sodium chloride of 100 wt. % potassium chloride and no sodium chloride, or between about 0 wt. % and about 5 wt. % sodium chloride and between about 95 wt. % and about 100 wt. % potassium chloride, or between about 0 wt. % and about 50 wt. % sodium chloride and between about 50 wt. % and about 100 wt. % potassium chloride, or between about 0 wt. % and about 40 wt. % sodium chloride and between about 60 wt. % and about 100 wt. % potassium chloride, or between about 0 wt. % and about 20 wt. % sodium chloride, and between about 80 wt. % and about 100 wt. % potassium chloride, or less than 50 wt. % sodium chloride and greater than 50 wt. % potassium chloride, or less than 49 wt. % sodium chloride and greater than 51 wt. % potassium chloride. The salt composition may contain less than about 5 wt %, 10 wt. %, 20 wt. %, 30 wt. %, 40 wt. %, 45 wt. %, 46 wt. %, 47 wt. %, 48 wt. %, 49 wt. % or 50 wt. % of sodium chloride relative to the total amount of sodium chloride and potassium chloride.

Further, the salt compositions may be low sodium NaCl compositions. In particular, the compositions may contain about 10 wt. % to 95 wt. % lower sodium than regular NaCl. The compositions may contain about 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 90 wt. %, 95 wt. %, or 100 wt. % lower sodium than regular NaCl. In embodiments, the compositions may contain about 40 wt. % to about 60 wt. % lower sodium than regular NaCl, or about 50 wt. % lower sodium than regular NaCl. If NaCl is desired, it can be added to a food product without being part of the composition of the present invention.

In embodiments, the salt compositions of the present invention may be combined with at least one taste modifier. The taste modifier is not limited by this description, and may include organic acids, amino acids, and nucleotides, including lysine, ribotide, and citric acid, and combinations thereof. In addition, the taste modifier may include other ingredients typically present in low solid food products, table NaCl, and NaCl substitute products, and combinations thereof.

In embodiments, the salt compositions of the present invention may be combined with at least one fat. The fat is not limited by this description, and may include fats and/or oils derived from animals, plants or microbes and combinations thereof. The fat can include non-hydrogenated or partially hydrogenated oils of plant and animal origin, such as soybean oil, canola oil, corn oil, cottonseed oil, rice bran oil, palm oil, peanut oil, sunflower oil, tallow, butter, and other vegetable oils, and combinations thereof. Also useful are both solid and liquid fractions of fractionated oils such as palm oil. Liquid and solid palm oil fractions or butter fractions are also useful fats of this invention. Also useful are oxidatively stable high monounsaturated oils such as high oleic canola, sunflower and soybean oils. The fat can have a melting point of below about 50° C., between about 30° C. and about 50° C., between about 35° C. and about 45° C., or about 40° C. In embodiments, fats having a melting point close to the body temperature are employed. In some embodiments, the fat is an oil or a soft fat. Examples of suitable oils and soft fats are triacylglycerols (TAG) derived from plants, animals or microorganisms. A TAG that is liquid at ambient temperature can be referred to as an oil, and if solid at ambient temperature can be referred to as a fat. As used herein, fat will be a generic term for fats and oils, unless otherwise indicated. As used herein, a soft-fat is a fat that melts at 50° C. or below. High-melting point fats, or hard fats, melt at greater than 50° C., and are not particularly suitable in the present invention as they solidify when the food product is cooled and can form undesirable white specks. High melting point fats can also have a waxy mouth-feel. Soft fats and oils are desirable because they melt at temperatures closer to body temperature and can avoid a waxy after-taste, and are less likely to form undesirable white specks when used in low solid foods.

In embodiments, the salt compositions of the present invention may be combined with at least one additive. Additives other than inorganic salts may be added after processing the composition. Additives may be selected from one or more of an antioxidant, an emulsifier, a dietary supplement, a phosphate, an anti-caking agent, a colorant, a NaCl enhancer, a flavor enhancer, a flavor modifier, a taste enhancer, an organic acid, an amino acid, an amino acid derivative, other ingredients typically present in table NaCl and NaCl substitute products, and combinations thereof.

For example, antioxidants may be added to fat to reduce the development of rancidity, thereby inhibiting the development of off-flavors in the food products. Exemplary methods are discussed in U.S. Patent Publication No. 2012/0128830. In embodiments, suitable antioxidants may include natural antioxidants such as tocopherols or rosemary extract among others or synthetic antioxidants such as BHA (butylated hydroxyanisole), BHT (butylated hydroxytoluene and TBHQ (tertiary butylhydroquinone), among others. The fats can be formulated with emulsifiers, e.g., to enhance their spreadability. Useful emulsifiers are food grade monoglycerides and diglycerides. Phosphates may be added to tenderize the food product that includes the salt composition. Suitable phosphates may include monosodium phosphate, tetrasodium pyrophosphate, sodium hexametaphosphate, monopotassium phosphate, tetrapotassium pyrophosphate, disodium phosphate, sodium tripolyphosphate, sodium acid pyrophosphate, dipotassium phosphate, and potassium tripolyphosphate. Colorants may be added to give the salt compositions a distinct color. Suitable natural colorants include caramel color, turmeric, annatto, beta-carotene, paprika oleoresin, red cabbage juice, beet juice, grape skin extract, and carmine, among others. Dietary supplements may be added to support a nutritious diet. Suitable dietary supplements include vitamins, minerals, herbs or other botanicals, amino acids, substances such as enzymes, metabolites, and combinations thereof. In embodiments, the salt compositions of the present invention include magnesium chloride, vitamin D and calcium as dietary supplements. All types of magnesium, vitamin D and calcium are contemplated. Suitable anti-caking agents may be included in the salt composition of the present invention to prevent caking or the formation of lumps, or to provide a free-flowing product and may include sodium hexacyanoferrate (II) (YPS), potassium hexacyanoferrate (II) tri hydrate (potassium ferrocyanide or YPP), tricalcium phosphate carbonate, magnesium carbonate, silicates, propylene glycol and silicon dioxide. In embodiments, an antioxidant used may also act as a colorant. In embodiments, the salt compositions of the present invention include magnesium chloride.

The salt compositions of the present invention may optionally contain other ingredients typically present in table NaCl and NaCl substitute products. Other suitable ingredients include iodide sources, flavors and flavor enhancers. An exemplary iodide source is KI with a dextrose stabilizer. Exemplary flavor enhancers include monosodium glutamate (MSG), meat extracts, protein hydrolysates, amino acids, hydrolyzed vegetable protein, autolyzed yeast and mononucleotide salts.

Various ranges of additives may be added, either alone or in any combination. For example, an antioxidant may be added in the amount of about 0.01 wt. % to about 1 wt. %, a dietary supplement may be added in the amount of about 0.1 wt. % to about 5 wt. %, a phosphate may be added in the amount of about 0.1 wt. % to about 10 wt. %, an anti-caking agent may be added in the amount of about 0.1 wt. % to about 2 wt. %, a colorant additive may be added in the amount of about 0.01 wt. % to about 1 wt. %, a salt enhancer may be added in the amount of about 0.01 wt. % to about 5 wt. %, an organic acid may be added in the amount of about 0.01 wt. % to about 5 wt. %, an amino acid may be added in the amount of about 0.01 wt. % to about 5 wt. %, an amino acid derivative may be added in the amount of about 0.01 wt. % to about 5 wt. %, a sugar may be added in the amount of about 0.1 wt. % to about 10 wt. %, or a sugar derivative additive may be added in the amount of about 0.01 wt. % to about 10 wt. %. In embodiments, from about 0.1% to about 2% by weight of silicon dioxide may be added to the composition, or about 1% by weight of silicon dioxide.

Methods of Preparation

Methods of preparing the potassium chloride compositions disclosed herein produce the potassium chloride compositions by combining a hydrophobic material, such as fat, with potassium chloride and/or salt composition. For example, the fat coats the salt composition particles, either partially or entirely. The process of making the salt compositions of the present invention can include mixing potassium chloride, a taste modifier, and a fat, at a temperature above the melting point of the fat, and cooling the mixture below the melting point of the fat to form the salt composition. A technique for coating the salt mixture with a hydrophobic layer to form the salt composition can include employing a processing aid, such as an alcohol, to coat the mixture with a hydrophobic layer, e.g., fat. The resulting salt compositions can be free-flowing particulates, as is common table salt. Additional methods include methods to make a food product; for example, combining a low solid food material and a salt composition, where the salt composition includes potassium chloride, a taste modifier, and a fat, that provides a hydrophobic coating on salt crystals and taste modifier.

In exemplary embodiments, the combining of the potassium chloride and fat may be conducted in any suitable vessel. At any time during when the potassium chloride and fat are combined, various mixing steps can occur. The mixing can occur using any suitable vessel or device. Methods of combining may include continuous processes and batch-wise processing, among others. Various mixers may be used, including mixing in a screw blender, a counter-rotating mixer, a paddle mixer, an extruder, and hydraulic and electric mixers, among others, and the mixer may be heated. Various types of heaters may be used, including a hot plate, a heated jacket and a steam jacket, among others. Steps of mixing may be performed prior to, during, or after other processing, such as extruding the components. For example, after the mixing, the mixture can be fed to an extruder. In addition, multiple steps of mixing may be used.

Before or during the mixing, a processing aid may be added. Adding a processing aid may, for example, increase the fluidity of the mixture. In addition, the processing aid may evaporate from the mixture, thereby avoiding additional steps of removing it, or the processing aid may be removed from the mixture by various means, including decanting and heating, evaporating under reduced pressure or processing conditions among others. The processing aid may be a food grade, such as a food grade alcohol.

For example, the alcohols may be C2-C8 alcohols and mixtures thereof, including ethanol, propanol (including both 1-propanol and 2-propanol), and mixtures thereof. The alcohols used in the present invention may contain some water. For example, distilled ethanol is 95 wt. % ethanol; that is, having a water:ethanol ratio of about 5 wt. %:95 wt. %. The use of food-grade alcohol may advantageously avoid any additional rinsing steps prior to contact or inclusion with a food product.

The steps of combining and/or mixing may be conducted for various amounts of time, for example for a time between about 1 minute and about 60 minutes. A suitable time for combining or mixing may be at least about 1 minute, 5 minutes, 10 minutes, 15 minutes, 20 minutes, 25 minutes, 30 minutes, 35 minutes, 40 minutes, 45 minutes, 50 minutes, 55 minutes, or 60 minutes or more. In further embodiments, the mixture is heated for about 15 minutes or for a time based on the heating capacity of the mixer. The mixture may be heated using any suitable vessel and/or device. The time and temperature of the heating process may vary depending upon how the heat is delivered to the components.

In further embodiments, the combination of the components may be heated to room temperature or higher during various steps of the methods disclosed herein to facilitate mixing. For instance, some fats may have a melting point temperature of about 40° C., and hence may be heated to this temperature to ensure better mixing.

Accordingly, the heating temperature may be from about 60° C. to about 250° C., or from about 80° C. to about 150° C., or from about 70° C. to about 130° C., or from about 70° C. to about 120° C., or from about 80° C. to about 110° C. and above. A suitable heating temperature may be one that facilitates the process of applying a hydrophobic layer on KCl crystals and facilitates the complete removal of any processing aid, such as alcohol. In embodiments, the temperature may be at least about 25° C., 35° C., 45° C., 50° C., 65° C., 75° C., 110° C., 120° C., 130° C., 150° C., or 175° C. or more. The heating may be conducted in an extruder at any of the temperatures set forth above. For example an extruder may have a barrel temperature of from about 60° C. to about 250° C., or a barrel temperature of about 110° C.

In additional optional steps, the mixture can be cooled to below the melting point of the fat to form the salt composition. Any suitable process and/or device may be used to cool the mixture, including air cooling, cooling in a refrigerator, and cooling using a fan. For example, the potassium chloride composition may be spread on trays and exposed to cool air to cool it. The cooling may be conducted at a temperature of lower than at least a melting point temperature of the fat. For instance, the cooling temperature may be from about 10° C. to about 40° C., or from about 15° C. to about 35° C. and below. In embodiments, the temperature may be at least below about 40° C., 35° C., 30° C., 25° C., 20° C., 15° C., or 10° C. or less. The composition can cool as discrete coated particles, that can be free-flowing. This provides functional, handling and use advantages, especially over compositions having a fused binding matrix, which can require separate grinding steps. Embodiments of the present invention do not require a separate grinding step.

In exemplary embodiments, the cooling of the mixture may be conducted for various amounts of time, for example for a time between about 1 minute and about 120 minutes. A suitable time for cooling may be at least about 1 minute, 5 minutes, 15 minutes, 30 minutes, 45 minutes, 60 minutes, 75 minutes, 90 minutes, 105 minutes, or 120 minutes or more. Further, drying steps may be combined with, or added after the cooling steps. Any suitable method of drying may be used or combined with other steps of the presently disclosed methods.

In any of the steps disclosed herein, NaCl may be added to the components and/or compositions. For example, NaCl may be added prior to, during, or after any of the mixing steps. Also, NaCl may also be added prior to, during, or after any of the heating steps. In addition, NaCl may also be added prior to, during, or after any of the cooling steps. Further, NaCl may also be added separately to the low solid food product. In embodiments, potassium chloride is present with NaCl in a ratio of greater than 50 wt. % of potassium chloride to less than 50 wt. % of NaCl. In embodiments, the salt composition may be blended with the food product prior to, during, or after adding NaCl.

A person of ordinary skill in the art will recognize that salt compositions of the present invention containing components such as potassium chloride compositions and/or sodium and/or non-sodium chloride salts, may be prepared by several methods, including those described above. Additional methods include adding the additional components prior to combining the components or adding the additional components after the components have been combined, separated, and/or dried. One skilled in the art will appreciate that the method of preparation depends upon the additional components to be included in the salt compositions and other factors and preferences.

In an embodiment of the present invention, potassium chloride is combined with a taste modifier and a fat, at a temperature above the melting point of the fat or alternately fat is pre-melted and added to the salt composition at ambient temperature. In additional embodiments, the potassium chloride may also be combined with other various components, and the components may be combined prior to, during, or after, the taste modifier and fat are combined. In embodiments, the composition may be combined in a heated device; for example, in a vessel with a steam jacket at temperatures ranging up to about 110° C. or higher. In embodiments, the composition may be combined for a time ranging up to about 20 minutes or more. Optionally, the mixture is cooled. Optionally, the mixture is dried. In embodiments, the mixture is formed as free-flowing particulates, and no subsequent grinding is necessary to form the particulates.

Methods of Use

The salt compositions of the present invention may be used as a NaCl substitute in food products, as a table NaCl substitute, or in spice mixtures and may be combined with low solid food products. Additionally, the salt compositions of the present invention can be used in commercial food manufacturing processes in order to reduce the proportion of sodium in the product while maintaining a taste similar to NaCl. For example, embodiments may include a food material and a potassium chloride composition. The food product may be a fried food product, a baked food product, or an extruded food product. The food product may also be selected from soups, porridges, sauces, baked goods, meat products, poultry products, snack products, dairy products, and breakfast cereals. Further representative food products include vegetables, fish, cheese, breads, frozen foods, canned foods and snack foods, such as potato chips, pretzels, peanuts, seeds, corn chips, tortilla chips, popcorn, crackers and bread sticks. The salt compositions may be applied to the foods in amounts sufficient to provide the flavor of NaCl as desired. The salt composition may further include at least one additive, and the additive may be selected from an antioxidant, a dietary supplement, a phosphate, an anti-caking agent, a colorant, a NaCl enhancer, a flavor enhancer, a flavor modifier, a taste enhancer, an organic acid, an amino acid, an amino acid derivative, and combinations thereof.

In embodiments, the food product may be heated to a temperature from about 150° F. to about 450° F. Without being bound by theory, it is believed that the food product including a food material and salt compositions of the present disclosure may be heated without imparting any significant adverse effect on the quality or taste of the food product. When food products were heated after the addition of prior NaCl substitute compositions, the organic components in the prior art NaCl substitute compositions could degrade, thereby causing an unsatisfactory taste or off-flavor. The hydrophobic coating (e.g., of fat) of the present invention can protect and hold the salt composition together during heating, resulting in a more desirable and effective salt composition. Thus, advantageously, the salt compositions of the present invention may allow the heating of food products after the addition of the presently disclosed potassium chloride compositions, without losing the advantageous attributes of the present salt compositions (e.g., improved taste and/or reduced sodium content).

A person of ordinary skill in the art will recognize that the taste aspect is very important with food production. Foods, in which the sodium content is reduced, frequently lose their taste and are regarded as tasteless by the consumer. A bitter character also frequently arises due to the use of other NaCl substitute compositions or NaCl compositions. Use of the salt compositions of the invention minimize, if not eliminate, these effects.

The following examples are intended to illustrate and explain exemplary embodiments. Embodiments of the disclosure, therefore, should not be limited to any of the details in these examples.

### EXAMPLES

### Example 1

In this example, KCl, with optionally added NaCl, fat (partially hydrogenated soybean oil, ADM, Decatur, Ill., Product Code 885800), citric acid, lysine, ribotide, emulsifier, rosemary extract and ethanol were mixed in a planetary mixer until a uniform mixture with no lumps was obtained. The mixture was sealed in plastic bags until extrusion began. The mixture was fed through a Wenger TX-57 twin screw extruder in a way such that the extruder motor was not overloaded and a uniform extruder torque could be obtained. Each formulation set forth in Tables 1 and 2 was extruded at 2 screw speeds (25 and 50 rpm). The extruder barrel temperatures were set at 110-110-110° C. and the extruder was used without a die. The extrudate product was collected in aluminum trays and allowed to cool at room temperature before it was sealed in plastic bags.

TABLE 1
100% KCl Formulation

| Ingredient | Wt. (kg) | Wt. % |
|---|---|---|
| KCl | 31.27 | 88.76 |
| Fat | 2.62 | 7.44 |
| Citric acid | 0.48 | 1.36 |
| Lysine | 0.66 | 1.87 |
| Ribotide | 0.2 | 0.57 |
| Total | 35.23 | |
| Emulsifier | 0.1 | 4% of fat |
| Rosemary Extract | 0.005 | 0.2% of fat |
| Ethanol | 5.6 | 16% of formulation |

TABLE 2
50 wt. % KCl, 50 wt. % NaCl Formulation

| Ingredient | Wt. (kg) | Wt. % |
|---|---|---|
| KCl | 6.7 | 44.58 |
| NaCl | 6.7 | 44.58 |
| Fat | 1.12 | 7.45 |
| Citric acid | 0.19 | 1.26 |
| Lysine | 0.28 | 1.86 |
| Ribotide | 0.04 | 0.27 |
| Total | 15.03 | |
| Emulsifier | 0.04 | 4% of fat |
| Rosemary Extract | 0.0022 | 0.2% of fat |
| Ethanol | 0.56 | 3.7% of formulation |

| Formulation | Screw | Motor | Product | Product pH |
|---|---|---|---|---|
| Code and (Table No.) | Speed | load | Moisture (%) | (10% solution) |
| 100% KCl25RPM (1) | 25 rpm | 18-25% | 0.91 | 5.74 |
| 100% KCl50RPM (1) | 50 rpm | 6% | 0.69 | 5.46 |
| 50% KCL25RPM (2) | 25 rpm | ~40% | 1 | 4.63 |
| 50% KCL50RPM (2) | 50 rpm | 4% | 1.17 | 4.38 |

### Example 2

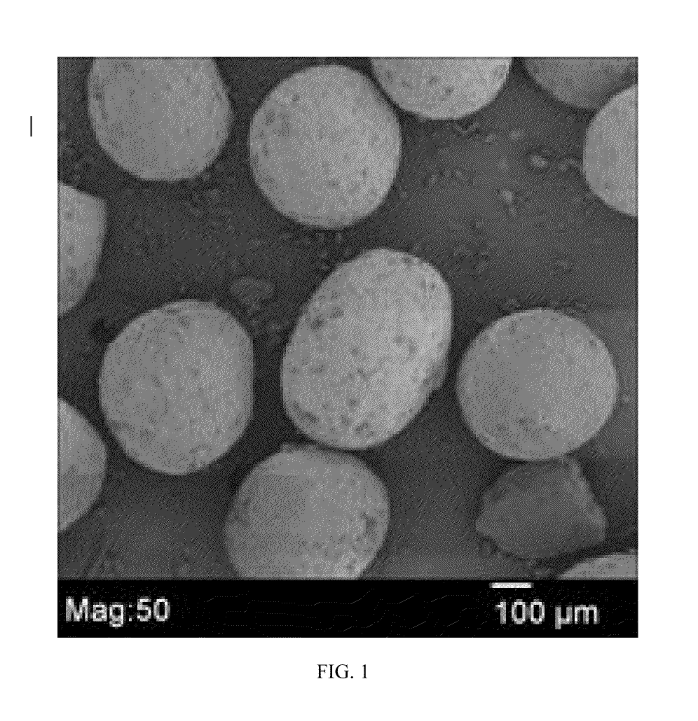

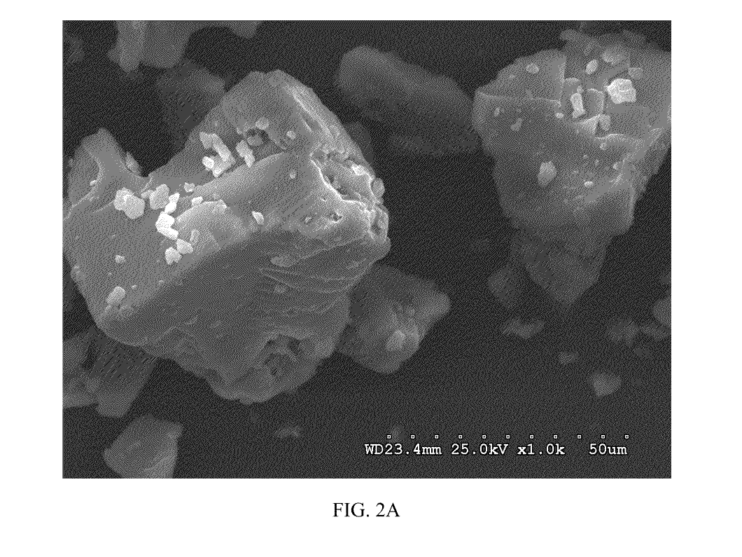

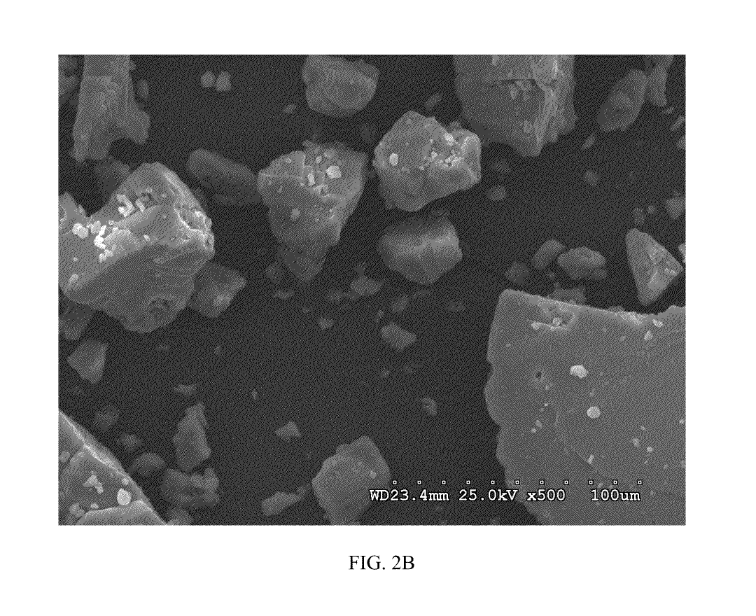

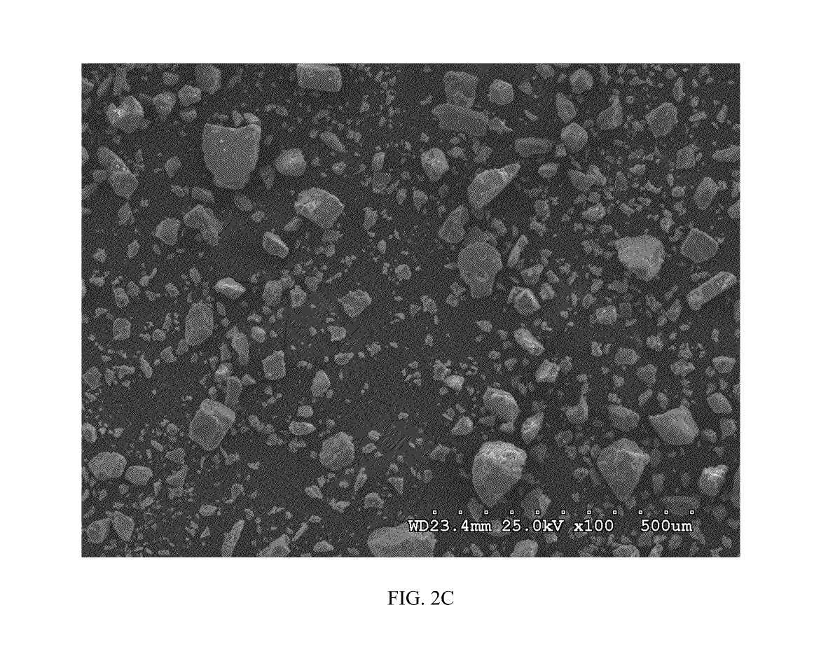

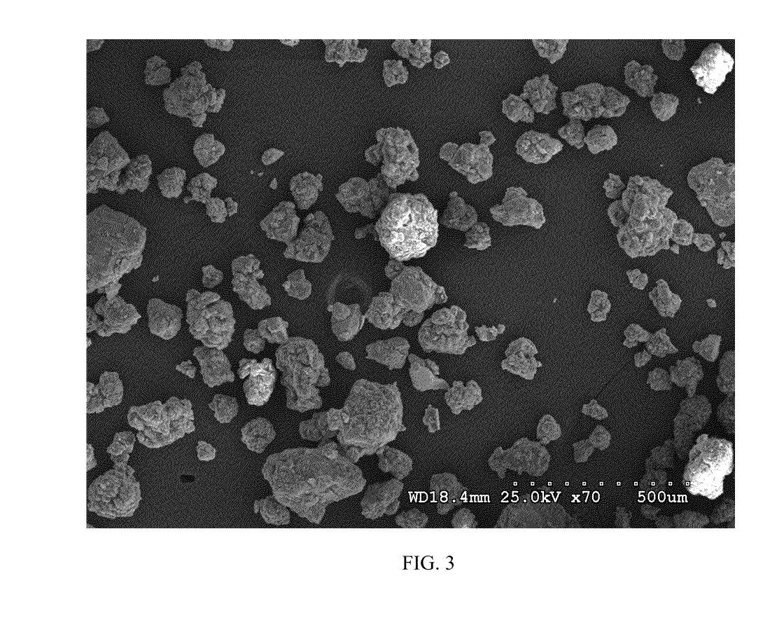

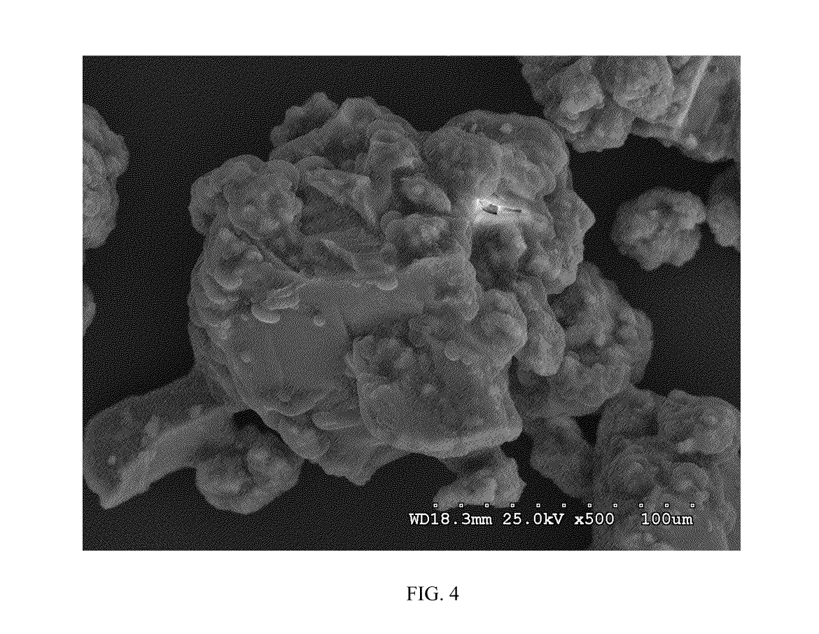

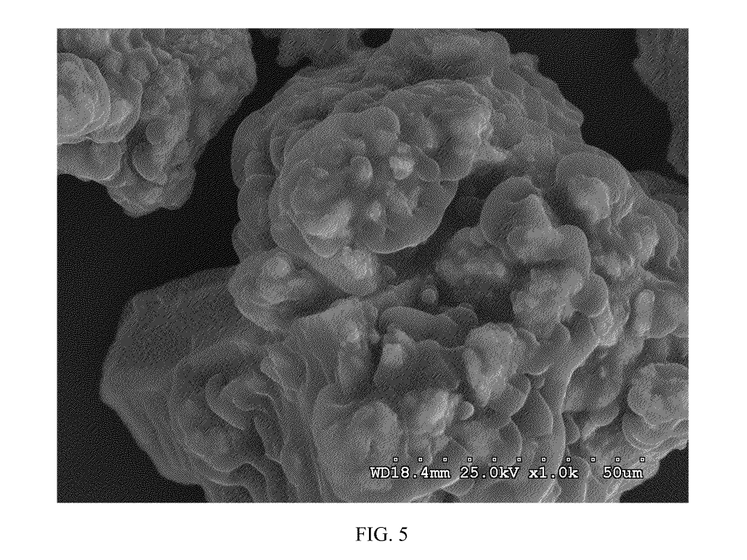

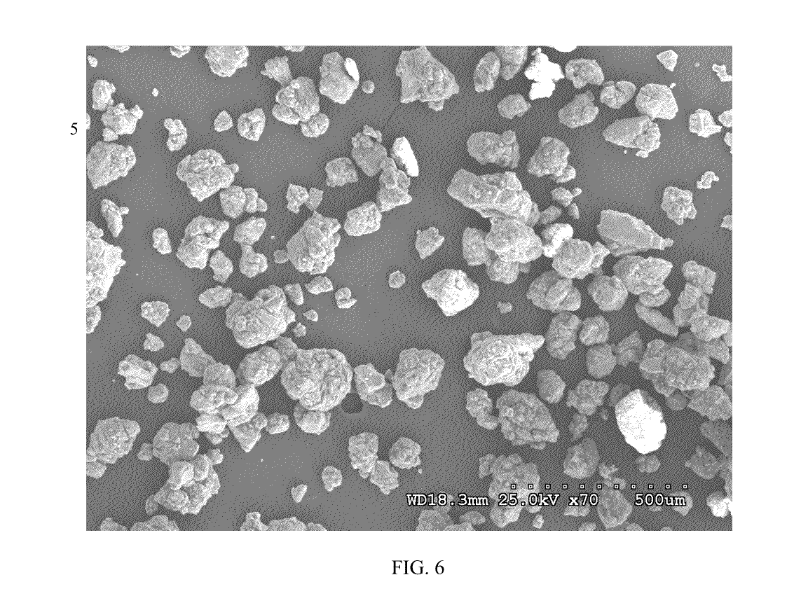

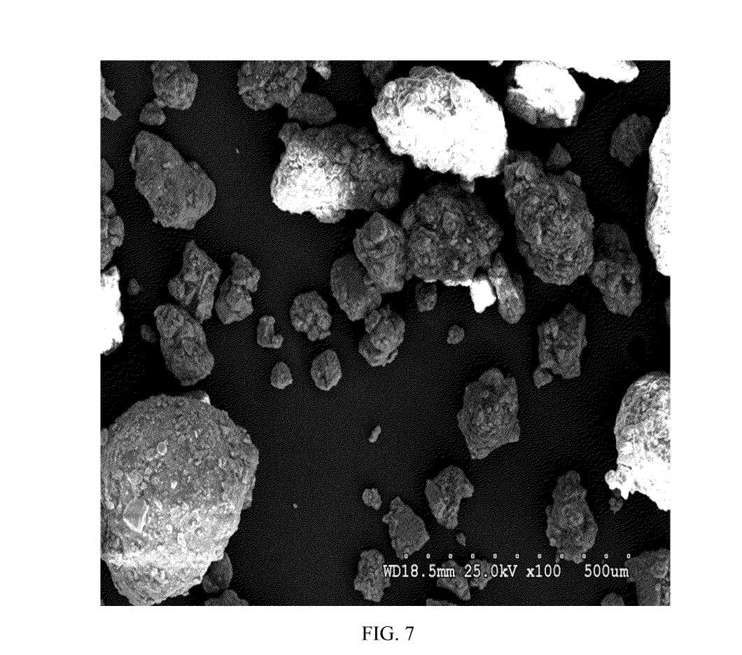

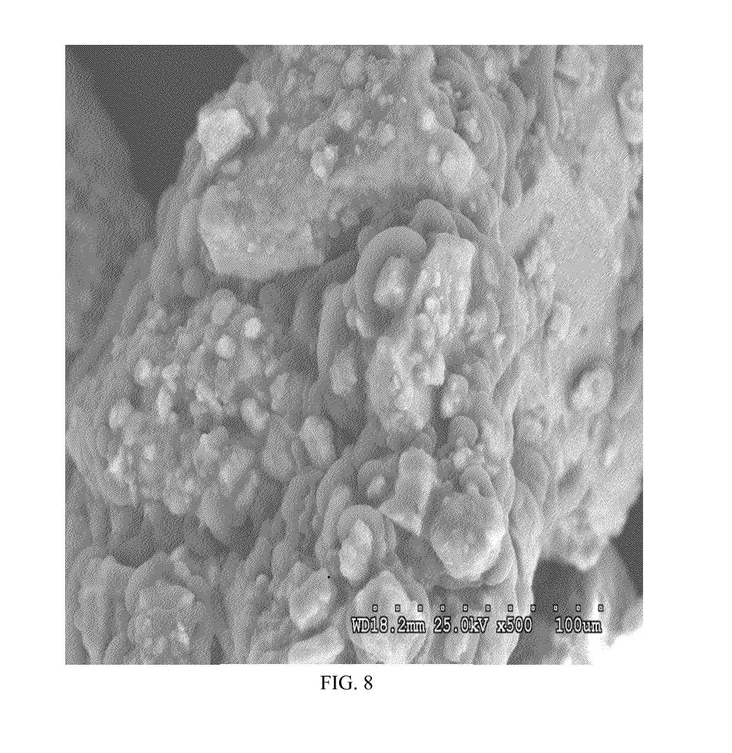

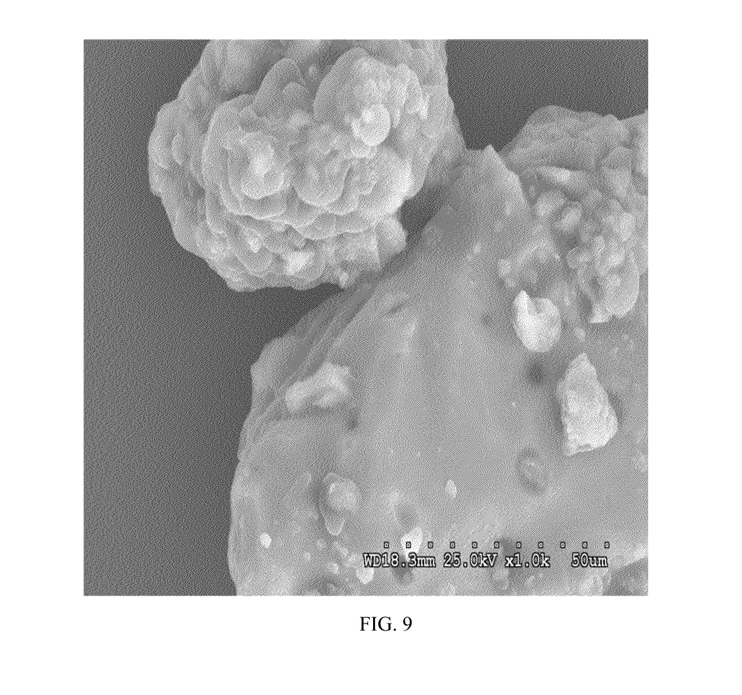

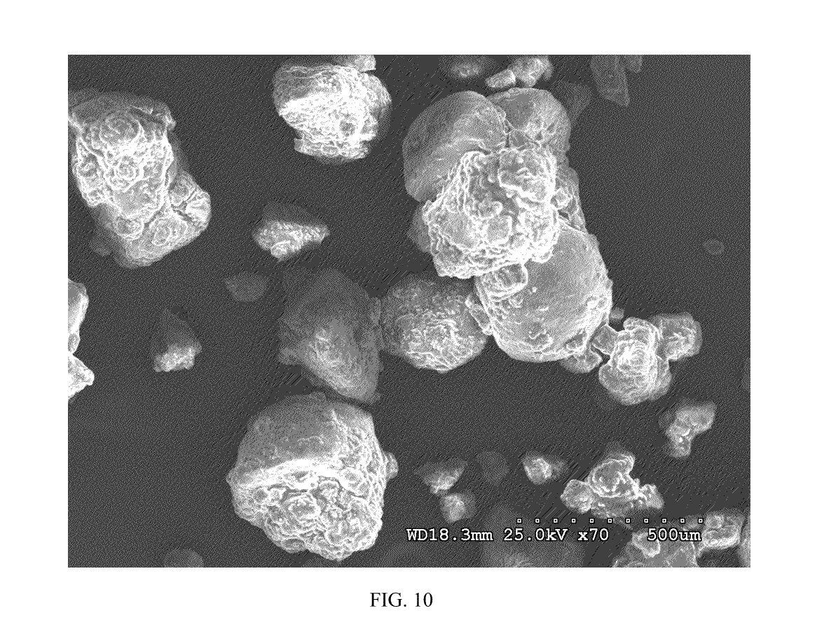

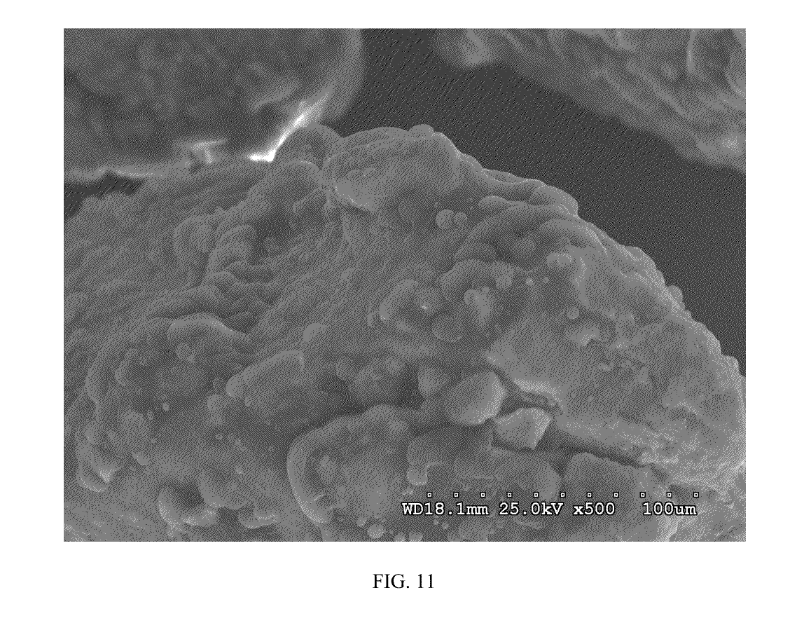

In this example, illustrative Scanning Electron Microscope (SEM) images were taken for various compositions of the present disclosure produced as described in Example 1. For comparison, FIG. 1 shows pure KCl without any additives or processing, at 50× magnification, the particles are rounded; and FIGS. 2A, 2B and 2C show pure KCl processed without additives, at 1000× 500× and 100× magnification, respectively. The irregular shaped particles in FIGS. 2A-C have sharp edges and flat surfaces. FIG. 3 shows a 70×SEM image of an illustrative 50 wt. % KCl, 50 wt. % NaCl Table 2 composition fed through an extruder at 25 rpm (50% KCL25 RPM). FIG. 4 shows a 500×SEM image of an illustrative 50 wt. % KCl, 50 wt. % NaCl Table 2 composition fed through an extruder at 25 rpm (50% KCL25 RPM). FIG. 5 shows a 1000×SEM image of an illustrative 50 wt. % KCl, 50 wt. % NaCl Table 2 composition fed through an extruder at 25 rpm (50% KCL25 RPM). FIG. 6 shows a 70×SEM image of an illustrative 100 wt. % KCl Table 1 composition fed through an extruder at 25 rpm (100% KCL25 RPM). FIG. 7 shows a 100×SEM image of an illustrative 100 wt. % KCl Table 1 composition fed through an extruder at 25 rpm (100% KCL25 RPM). FIG. 8 shows a 500×SEM image of an illustrative 100 wt. % KCl Table 1 composition fed through an extruder at 25 rpm (100% KCL25 RPM). FIG. 9 shows a 1000×SEM image of an illustrative 100 wt. % KCl Table 1 composition fed through an extruder at 25 rpm (100% KCL25 RPM). FIG. 10 shows a 70×SEM image of an illustrative 100 wt. % KCl Table 1 composition fed through an extruder at 50 rpm (100% KCL50 RPM). FIG. 11 shows a 500×SEM image of an illustrative 100 wt. % KCl Table 1 composition fed through an extruder at 50 rpm (100% KCL50 RPM).

As can be seen from the SEM images of FIGS. 3-11, the salt particles have a coating of fat. This is apparent from the fact that very few sharp edges and flat surfaces are observed. Sharp edges and flat surfaces are characteristic of a processed uncoated crystalline salt as shown in FIGS. 2A-C. In FIGS. 3-11, a coating of fat, coated on the salt surfaces, can be observed instead. Images of product when 100% KCl and 50 rpm are used (100% KCL50 RPM) reveal that the granules produced under the stated conditions are larger in size than those extruded at 25 rpm, irrespective of KCl content. Images of product when 100% KCl and 50 rpm are used (100% KCL50 RPM) reveal a smoother coating than those extruded at 25 rpm, irrespective of KCl content.

### Example 3

This example was conducted to evaluate low sodium salt compositions under cooking conditions in low solid foods. Trials were conducted using a small pressure cooker. Sodium level was reduced about 50% compared to table NaCl.

Sample Preparation and Handling:

Swanson's Unsalted Chicken Stock was held at room temperature until salted with the four treatments. The salt treatments were added at the 1½% level. The four treatments were 1) full Cargill TopFlo Salt (NaCl, Control), 2) 50% replacement of the TopFlo Salt with a comparison low sodium salt, 3) 50% replacement of the TopFlo Salt with 100% KCl composition (Example 1, Table 1), and 4) 100% replacement of TopFlo Salt with 50% KCl composition (Example 1, Table 2). The salted broths were then heated in a pressure cooker for 5 minutes once they were under full pressure. The samples were stored in the refrigerator until they were needed. On the day of the taste panel, the broth was heated to 140° F. and then poured into preheated insulated carafes. The samples were served in 1 oz plastic cups, labeled with the sample's assigned three digit random number, one sample at a time in a predetermined random order. Panelists were provided room temperature water and unsalted saltine crackers to clear their palate between samples. Data was collected using the SIMS 2000 computer system; a 15 point scale was used. A total of 39 people participated. The four treatments (two batches each) were:

1. 100 wt. % Cargill TopFlo Salt (Control) 11.25 g TopFlo+738.75 g broth.
2.50% KCl (Comparison Sample A) 5.625 g TopFlo+5.625 g comparison sample A+738.75 g broth
3. 100% KCl (Sample 3) 5.625 g TopFlo+5.625 g sample+738.75 g broth
4.50% KCl/50% NaCl (Sample 4) 11.25 g sample+738.75 g broth

The Control NaCl salt is Cargill TopFlo Salt

Comparisons Sample A consisted of 80 wt. % KCl, 15 wt. % rice flour, 5 wt. % citric acid, lysine and water.

Sample 3 was prepared as in Example 1, Table 1.

Sample 4 was prepared as in Example 1, Table 2.

The Control sample (#1) (unsalted chicken broth+1.5% TopFlo Salt) contained 597 mg of Na/100 g of broth.

The comparison Sample A (#2) 0.75%+0.75% TopFlo Salt contained 351 mg of Na/100 g of broth, a 41.2% reduction in Na compared to the control sample.

Sample 3 (#3) was 0.75% of formulation of the present invention as described in Example 1, Table 1 (with KCl only as salt in the formula)+0.75% TopFlo Salt, and contained 325 mg of Na/100 g of broth, a 45.5% reduction in Na compared to the Control sample.

Sample 4 (#4) was 1.5% formulation of the present invention as described in Example 1, Table 2 (with 50 wt. %/50 wt. % ratio of KCl/NaCl) and contained 271 mg of Sodium/100 g of broth, a 54.6% reduction in Na compared to the Control sample.

A small Hawkins pressure cooker was used to process all of the samples separately in duplicate. The 738.75 grams of the broth was weighed and added to the pressure cooker, then the salts (total of 11.25 grams) were added, and the sample was heated in the closed pressure cooker until it reached the “rocker” sound on the pressure gauge. The pressure cooker was kept on high heat for 1 minute, then turned to medium and held for 4 additional minutes to maintain pressure. Then the pressure cooker was carefully cooled by placing into a pan of cool water, and once pressure was released, distilled water was added back so that the contents equaled 750 grams. The two samples from each treatment were then blended and divided to reserve samples for panels sessions the following day.

Samples were heated to 140 F and held in insulated thermoses until poured into individual 1 oz. portions just prior to tasting.

The samples of the extruded product (#3, #4) seemed a little powdery in appearance and cloudy when they were cooled after processing, but seemed to clear up after final heating. A little oily surface appeared on these two samples.

Results and Discussion:

Because of the size of the data set, three tables were developed and these are presented below. Each set of data in a table will be discussed immediately after the table. Data that are significantly different at P=5% is bolded. All data, except the salt level, are presented as Least Squares (L.S.) Means, which is an average that is weighted by the whole data set. For salt level information comparisons were made using the Just About Right (JAR) scale and for this data, the medians were calculated. The median reflects the midpoint of the data, this means half of the responses were above and half of the responses were below the calculated number. The median gives a more balanced perspective on the JAR than the average and is a better guide for making decisions on how to modify the product formulation.

TABLE 3
Least Squares Means* for the Appearance Attribute of Chicken Broth

| | Overall |
|---|---|
| Sample | Appearance¹ |
| Control | 10.788 |
| Comparison Sample A | 10.75 |
| Sample 3 | 9.74 |
| Sample 4 | 10.34 |

*Means within an attribute (column) with a different letter are significantly different at P = 5%
¹Where 0 = Very Undesirable and 15 = Very Desirable

Table 3 shows the appearance attribute. There were no significant differences detected.

TABLE 4
Least Squares Means* for the Flavor Attributes of Chicken Broth

| | | Salt | Chicken | Off | Overall Flavor |
|---|---|---|---|---|---|
| Sample | Saltiness¹ | Level* | Flavor¹ | Flavor¹ | Acceptability² |
| Control | 10.19a | 9.66 | 8.10 | 4.66 | 8.41 |
| Comp. | 7.60b | 7.48 | 8.03 | 4.96 | 8.14 |
| Sample A | | | | | |
| Sample 3 | 8.65c | 7.60 | 8.20 | 4.03 | 8.74 |
| Sample 4 | 7.59b | 7.14 | 8.57 | 4.07 | 8.43 |

*Means within an attribute (column) with a different letter are significantly different at P = 5%
¹Where 0 = Lacking and 15 = Intense
²Where 0 = Very Undesirable and 15 = Very Desirable
*This value is the median; the closer the median (JAR) results to 7.50 the better. The JAR Scale is where 0 = Too little; 7.5 = Just About Right and 15 = Too Much

Table 4 shows the taste and flavor attributes. There was a significant difference found in the saltiness attribute. The Control sample was perceived to be saltier than the other samples. Sample 3 was perceived to be saltier than Comparison Sample A and Sample 4, but not as salty as the Control sample. There were no other significant differences in the other attributes.

In the salt level (Just About Right scale) the control sample was rated at 9.66 which is in the “too much” side of the Just About Right scale. The test samples were all much closer to the optimal Just About Right level of 7.5 at a value of 7.60 (Sample 3), 7.48 (Comparison Sample A), and 7.14 (Sample 4).

TABLE 5
Least Squares Means* for the Aftertaste and Overall Acceptability
Attributes of Chicken Broth

| | | Overall | Overall |
|---|---|---|---|
| | Aftertaste¹ | Aftertaste | Sample |
| Sample | Off Flavor | Acceptability² | Acceptability² |
| Control | 4.67 | 8.56 | 8.00 |
| Comparison Sample A | 4.24 | 8.63 | 8.29 |
| Sample 3 | 4.21 | 8.79 | 8.92 |
| Sample 4 | 4.54 | 8.52 | 8.49 |

Means within an attribute (column) with a different letter are significantly different at P = 5%
¹Where 0 = Lacking and 15 = Intense
²Where 0 = Very Undesirable and 15 = Very Desirable

Table 5 shows the aftertaste and the overall sample acceptability; these attributes were not significantly different.

In summary, there was a significant difference detected in the saltiness attribute at the 5% level (P<0.05). The Control sample was perceived to be saltier than the other samples. Sample 3 was also perceived to be saltier than Comparison Sample A and Sample 4, but not as salty as the Control sample. In the salt level (Just About Right scale) the Control sample was rated at 9.66 which is in the “too much” side of the Just About Right scale. The test samples were all much closer to the optimal Just About Right level of 7.5 at a value of 7.60 (Sample 3), 7.48 (Comparison Sample A), and 7.14 (Sample 4).

### Example 4

In this example, KCl, fat (Canola oil), citric acid, lysine, ribotide, emulsifier and rosemary extract were combined at room temperature. The amounts of KCl, citric acid, lysine, ribotide, emulsifier and antioxidant (rosemary extracts) set forth in Table 6 were mixed in a planetary mixer (Model C-100, Hobart Corp., Troy, Ohio). The amount of canola oil set forth in Table 6 was added to the salt formulation and mixed for 30 minutes to obtain salt crystals with a uniform oil coating on them.

TABLE 6
100% KCl Formulation

| Ingredient | Wt. (g) | Wt. % |
|---|---|---|
| KCl | 177.5 | 88.76 |
| Canola Oil | 14.88 | 07.44 |
| Citric acid | 2.72 | 1.36 |
| Lysine | 3.74 | 1.87 |
| Ribotide | 1.14 | 0.57 |
| Total | 200 | |
| Emulsifier | 0.6 | 4% of fat |
| Rosemary Extract | 0.03 | 0.2% of fat |

This process can be used for coating fat on the salt formulation without using an extruder. The fat, if solid at room temperature, can be heated to form a melt, prior to mixing with the salt formulation. Instead of a planetary mixer (e.g., Model C-100, Hobart Corp., Troy, Ohio), a mixer with a heater can be used, which can be useful for effectively coating a salt composition with fat.

The invention illustratively disclosed herein suitably may be practiced in the absence of any element, which is not specifically disclosed herein. It is apparent to those skilled in the art, however, that many changes, variations, modifications, other uses, and applications to the method are possible, and also changes, variations, modifications, other uses, and applications which do not depart from the spirit and scope of the invention are deemed to be covered by the invention, which is limited only by the claims which follow.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. The features of the embodiments of the invention may be combined in alternate embodiments other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations, combinations, and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for preparing a salt composition, comprising:
combining potassium chloride, a taste modifier, and fat, to provide a coating of fat on particles comprising potassium chloride and a taste modifier.

2. The method of claim 1, wherein the taste modifier is selected from the group consisting of organic acids, amino acids, and nucleotides.

3. The method of claim 1, wherein the taste modifier is selected from the group consisting of lysine, ribotide, and citric acid.

4. The method of claim 1, wherein the fat forms a coating over at least 90% of the surface area of potassium chloride particles.

5. The method of claim 1, wherein the fat coats at least 70 wt. % of individual potassium chloride particles.

6. The method of claim 1, wherein the fat coats at least 90% of the surface area of at least 90 wt. % of the potassium chloride.

7. The method of claim 1, wherein the resulting composition is free-flowing particulates.

8. The method of claim 1, further comprising combining an antioxidant with the fat.

9. The method of claim 1, wherein the step of combining is conducted in a mixer.

10. The method of claim 9, wherein the mixer is heated.

11. The method of claim 1, wherein the step of combining is conducted in an extruder.

12. The method of claim 1, further comprising, after combining, feeding the combination to an extruder.

13. The method of claim 1, further comprising combining NaCl with the potassium chloride, the taste modifier, and the fat.

14. The method of claim 13, wherein the potassium chloride is blended with the NaCl in a KCl:NaCl ratio of greater than 50 weight % of the potassium chloride to less than 50 weight % of the NaCl.

15. The method of claim 13, wherein the potassium chloride is blended with the NaCl in a KCl:NaCl ratio of greater than about 95 weight % of the potassium chloride to less than about 5 weight % of the NaCl.

16. The method of claim 1, wherein the fat is selected from the group consisting of soft fats, oils and combinations thereof.

17. The method of claim 1, wherein the fat is selected from the group consisting of partially hydrogenated soybean oil, partially hydrogenated canola oil, vegetable oil, and combinations thereof.

18. The method of claim 1, wherein the fat has a melting point of less than about 50° C.

19. The method of claim 1, wherein the fat has a melting point of about 40° C.

20. The method of claim 1, further comprising employing a food grade processing aid to assist in combining the potassium chloride, the taste modifier, and the fat.

21. The method of claim 20, wherein the processing aid is a food grade alcohol.

22. The method of claim 20, wherein the processing aid is ethanol.

23. The method of claim 11, wherein the extruder has a barrel temperature of between about 60° C. and about 200° C.

24. The method of claim 11, wherein the extruder has a barrel temperature of about 110° C.

25. The method of claim 20, further comprising removing the processing aid from the salt composition.

26. A salt composition, comprising potassium chloride, a taste modifier and a fat coating the potassium chloride.

27. The salt composition of claim 26, wherein the taste modifier is selected from the group consisting of lysine, ribotide, and citric acid.

28. The salt composition of claim 26, wherein the fat forms a coating over at least 90% of the surface area of potassium chloride particles.

29. The salt composition of claim 26, wherein the fat coats at least 70 wt. % of individual potassium chloride particles.

30. The salt composition of claim 26, wherein the composition is free-flowing particulates.

31. The salt composition of claim 26, further comprising NaCl.

32. The salt composition of claim 31, wherein the potassium chloride is blended with the NaCl in a KCl:NaCl ratio of greater than about 95 weight % of the potassium chloride to less than about 5 weight % of the NaCl.

33. The salt composition of claim 26, wherein the fat is selected from the group consisting of partially hydrogenated soybean oil, partially hydrogenated canola oil, vegetable oil, and combinations thereof.

34. The salt composition of claim 26, wherein the fat has a melting point of less than about 50° C.

35. A food product, comprising:
a low solid food material; and
a salt composition comprising potassium chloride, a taste modifier, and a fat.

36. The food product of claim 35, wherein the low solid food material is selected from the group consisting of soups, porridges, sauces, dairy products, gravies, and salad dressings.

37. The food product of claim 35, further comprising at least one additive selected from the group consisting of an antioxidant, a dietary supplement, a phosphate, an anti-caking agent, a colorant, a NaCl enhancer, a flavor enhancer, a flavor modifier, a taste enhancer, an organic acid, an amino acid, an amino acid derivative, and combinations thereof.

38. The food product of claim 35, wherein the taste modifier is selected from the group consisting of organic acids, amino acids, and nucleotides.

39. The food product of claim 35, wherein the fat forms a coating over at least 90% of the surface area of potassium chloride particles.

40. The food product of claim 39, wherein the fat coats at least 70 wt. % of individual potassium chloride particles.

41. The food product of claim 35, further comprising NaCl, wherein the potassium chloride and the NaCl are in a KCl:NaCl ratio of greater than about 50 weight % of the potassium chloride to less than about 50 weight % of the NaCl.

42. The food product of claim 35, wherein the fat is selected from the group consisting of partially hydrogenated soybean oil, partially hydrogenated canola oil, vegetable oil, and combinations thereof.

43. The food product of claim 35, wherein the fat has a melting point of less than about 50° C.

44. A method to make a food product, comprising:
combining a low solid food material and a salt composition, wherein the salt composition comprises potassium chloride, a taste modifier, and a fat coating the potassium chloride.

45. The method of claim 44, wherein the food product is selected from the group consisting of soups, porridges, sauces, dairy products, gravies and salad dressings.

46. The method of claim 44, further comprising at least one additive selected from the group consisting of an antioxidant, a dietary supplement, a phosphate, an anti-caking agent, a colorant, a NaCl enhancer, a flavor enhancer, a flavor modifier, a taste enhancer, an organic acid, an amino acid, an amino acid derivative, and combinations thereof.

47. The method of claim 44, wherein the taste modifier is selected from the group consisting of lysine, ribotide, and citric acid.

48. The method of claim 44, wherein the fat coats at least 90% of the surface area of at least 90 wt. % of the potassium chloride.

49. The method of claim 44, wherein the salt composition further comprises NaCl and the potassium chloride is blended with the NaCl in a KCl:NaCl ratio of greater than about 95 weight % of the potassium chloride to less than about 5 weight % of the NaCl.

50. The method of claim 44, wherein the fat is selected from the group consisting of partially hydrogenated soybean oil, partially hydrogenated canola oil, vegetable oil and combinations thereof.

51. The method of claim 44, wherein the fat has a melting point of less than about 50° C.

52. The method of claim 44, further comprising combining the combination of the low solid food material and the salt composition with NaCl.

53. The method of claim 52, wherein the potassium chloride and the NaCl are in a KCl:NaCl ratio of greater than 50 weight % of the potassium chloride to less than 50 weight % of the NaCl.
